(19) United States
(12) Patent Application Publication
(10) Pub. No.: US 2026/0353246 A1
(43) Pub. Date: Nov. 5, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Mengzhen WANG, Shenzhen (CN); Lin CHEN, Shenzhen (CN); Tao QI, Shenzhen (CN)

(73) Assignee: ZTE CORPORATION, Shenzhen (CN)

(21) Appl. No.: 19/712,933

(22) Filed: Jun. 18, 2026

Related U.S. Application Data
(63) Continuation of application No. PCT/CN2024/075102, filed on Jan. 31, 2024.

(51) Int. Cl. H04W 40/22; H04W 76/14; H04W 88/04

(52) U.S. Cl. CPC H04W 40/22; H04W 76/14; H04W 88/04

(57) ABSTRACT

A wireless communication method is disclosed. The method comprises transmitting, by a wireless communication node, multi-hop sidelink configuration information to two or more relay wireless communication terminals and a remote wireless communication terminal, wherein the remote wireless communication terminal communicates with the wireless communication node via the two or more relay wireless communication terminals.

### CROSS-REFERENCE TO RELATED PATENT APPLICATIONS

This application is a Continuation of International Application No. PCT/CN2024/075102, filed Jan. 31, 2024, incorporated herein by reference in its entirety.

### TECHNICAL FIELD

This document is directed generally to wireless communications, and in particular to 5^{th} generation (5G) communications or 6^{th} generation (6G) communications.

### BACKGROUND

In 5G communication, U2N (User Equipment (UE)-to-Network) relays are widely used. U2N relays allow the network to extend its coverage to a remote UE. The U2N relay UE is a UE that provides functionality to support connectivity to the network for U2N Remote UE(s). However, the application of a U2N relays is still a topic to be discussed.

### SUMMARY

This document relates to methods, systems, and computer program products for a wireless communication.

One aspect of the present disclosure relates to a wireless communication method. In an embodiment, the wireless communication method includes: transmitting, by a wireless communication node, multi-hop sidelink configuration information to two or more relay wireless communication terminals and a remote wireless communication terminal, wherein the remote wireless communication terminal communicates with the wireless communication node via the two or more relay wireless communication terminals.

Various embodiments may preferably implement the following features:

Preferably or in some embodiments, the multi-hop sidelink configuration information comprises at least one of:
a local identifier of the remote wireless communication terminal;
a parent relay identifier of a parent relay wireless communication terminal;
a local identifier of an intermediate relay wireless communication terminal;
a bearer mapping; or
an identifier of a next-hop relay wireless communication terminal.

Preferably or in some embodiments, the bearer mapping comprises at least one of:
a bearer mapping configuration for the remote wireless communication terminal comprising at least one of:
   a Radio Bearer, RB, identifier; or
   an egress PC5 RLC channel identifier;
a bearer mapping configuration for an intermediate relay wireless communication terminal comprising at least one of:
   an RB identifier;
   an egress PC5 RLC channel identifier for an uplink transmission; or
   an egress PC5 RLC channel identifier for a downlink transmission;
a bearer mapping configuration for an intermediate relay wireless communication terminal acting as a UE-to-Network, U2N, relay wireless communication terminal comprising at least one of:
   an RB identifier;
   a Uu Radio Link Control, RLC, channel identifier of a served intermediate relay wireless communication terminal;
   an egress Uu RLC channel identifier for an uplink transmission; or
   an egress PC5 RLC channel identifier for a downlink transmission;
a bearer mapping configuration for an intermediate relay wireless communication terminal acting as a U2N remote wireless communication terminal comprising at least one of:
   a Uu RLC channel identifier of the intermediate relay wireless communication terminal; or
   an egress PC5 RLC channel identifier; or
a bearer mapping configuration for a root relay wireless communication terminal comprising at least one of:
   an RB identifier;
   a Uu RLC channel identifier of a served intermediate relay wireless communication terminal;
   an egress Uu RLC channel identifier for an uplink transmission; or
   an egress PC5 RLC channel identifier for a downlink transmission.

Preferably or in some embodiments, the RB identifier is an end-to-end radio bearer between the remote wireless communication terminal and the wireless communication node.

Preferably or in some embodiments, at least one of the following applies:
the local identifier of the remote wireless communication terminal is uniquely allocated under the wireless communication node, under a root relay wireless communication terminal, or under the parent relay wireless communication terminal;
the parent relay identifier is uniquely allocated under the wireless communication node;
the local identifier of the intermediate relay wireless communication terminal is uniquely allocated under the wireless communication node or under a root relay wireless communication terminal;
the identifier of the next-hop relay wireless communication terminal comprises at least one of a local identifier of the next-hop relay wireless communication terminal or a Layer 2, L2, identifier of the next-hop relay wireless communication terminal, wherein the local identifier of the next-hop relay wireless communication terminal is uniquely allocated under the wireless communication node or under a root relay wireless communication terminal; or
the parent relay wireless communication terminal is directly connected to the remote wireless communication terminal for providing a U2N functionality to support a connectivity to the wireless communication node for the remote wireless communication terminal.

Preferably or in some embodiments, the wireless communication method further comprises at least one of:
receiving, by the wireless communication node from a root relay wireless communication terminal, a Sidelink Relay Adaptation Protocol, SRAP, Protocol Data Unit, PDU, of the remote wireless communication terminal or a served relay wireless communication terminal; or
transmitting, by the wireless communication node to a root relay wireless communication terminal, an SRAP PDU, of the remote wireless communication terminal or a served relay wireless communication terminal;
wherein an SRAP header of the SRAP PDU comprises at least one of:
   an identifier of a served relay wireless communication terminal,
   an identifier of the remote wireless communication terminal,
   an RB identifier, or
   a Uu RLC channel identifier of a served relay wireless communication terminal.

Another aspect of the present disclosure relates to a wireless communication method. In an embodiment, the wireless communication method includes: performing, by a relay wireless communication terminal, a packet forwarding between a wireless communication node and a remote wireless communication terminal based on multi-hop sidelink configuration information received from the wireless communication node to allow the remote wireless communication terminal and the wireless communication node to perform a communication via two or more relay wireless communication terminals.

Various embodiments may preferably implement the following features:

Preferably or in some embodiments, the multi-hop sidelink configuration information comprises at least one of:
a local identifier of the remote wireless communication terminal;
a parent relay identifier of a parent relay wireless communication terminal;
a local identifier of an intermediate relay wireless communication terminal;
a bearer mapping; or
an identifier of a next-hop relay wireless communication terminal.

Preferably or in some embodiments, the bearer mapping comprises at least one of:
a bearer mapping configuration for an intermediate relay wireless communication terminal comprising at least one of:
   an RB identifier;
   an egress PC5 RLC channel identifier for an uplink transmission; or
   an egress PC5 RLC channel identifier for a downlink transmission;
a bearer mapping configuration for an intermediate relay wireless communication terminal acting as a UE-to-Network, U2N, relay wireless communication terminal comprising at least one of:
   an RB identifier;
   a Uu Radio Link Control, RLC, channel identifier of a served intermediate relay wireless communication terminal;
   an egress Uu RLC channel identifier for an uplink transmission; or
   an egress PC5 RLC channel identifier for a downlink transmission;
a bearer mapping configuration for an intermediate relay wireless communication terminal acting as a U2N remote wireless communication terminal comprising at least one of:
   a Uu RLC channel identifier of the intermediate relay wireless communication terminal; or
   an egress PC5 RLC channel identifier; or
a bearer mapping configuration for a root relay wireless communication terminal comprising at least one of:
   an Rb identifier;
   a Uu RLC channel identifier of a served intermediate relay wireless communication terminal;
   an egress Uu RLC channel identifier for an uplink transmission; or
   an egress PC5 RLC channel identifier for a downlink transmission.

Preferably or in some embodiments, at least one of the following applies:
the local identifier of the remote wireless communication terminal is uniquely allocated under the wireless communication node, under a root relay wireless communication terminal, or under the parent relay wireless communication terminal;
the parent relay identifier is uniquely allocated under the wireless communication node;
the local identifier of the intermediate relay wireless communication terminal is uniquely allocated under the wireless communication node or under a root relay wireless communication terminal;
the identifier of the next-hop relay wireless communication terminal comprises at least one of a local identifier of the next-hop relay wireless communication terminal or a Layer 2, L2, identifier of the next-hop relay wireless communication terminal, wherein the local identifier of the next-hop relay wireless communication terminal is uniquely allocated under the wireless communication node or under a root relay wireless communication terminal; or
the parent relay wireless communication terminal is directly connected to the remote wireless communication terminal for providing a U2N functionality to support a connectivity to the wireless communication node for the remote wireless communication terminal.

Preferably or in some embodiments, the wireless communication method further comprises at least one of:
receiving, by the relay wireless communication terminal from the remote wireless communication terminal or an intermediate relay wireless communication terminal, a Sidelink Relay Adaptation Protocol, SRAP, Protocol Data Unit, PDU, of the remote wireless communication terminal;
transmitting, by the relay wireless communication terminal to an intermediate relay wireless communication terminal or a root relay wireless communication terminal, a Sidelink Relay Adaptation Protocol, SRAP, Protocol Data Unit, PDU, of the remote wireless communication terminal, by mapping the SRAP PDU to an egress PC5 RLC channel for uplink transmission, based on a bearer mapping received from the wireless communication node;
receiving, by the relay wireless communication terminal from a root relay wireless communication terminal or an intermediate relay wireless communication terminal, an SRAP PDU of the remote wireless communication terminal; or
transmitting, by the relay wireless communication terminal to a next-hop relay wireless communication terminal, an SRAP PDU, of the remote wireless communication terminal, particularly by mapping the SPAP PDU to an egress PC5 RLC channel towards the next-hop relay wireless communication terminal, based on an identifier of the next-hop relay wireless communication terminal configured by the wireless communication node or uplink routing information recorded by the relay wireless communication terminal, and a bearer mapping received from the wireless communication node.

Preferably or in some embodiments, an SRAP header of the SRAP PDU comprises at least one of:
an identifier of a served relay wireless communication terminal,
an identifier of the remote wireless communication terminal,
a parent relay identifier of a parent relay wireless communication terminal;
an RB identifier, or
a Uu RLC channel identifier of a served relay wireless communication terminal.

Preferably or in some embodiments, the identifier of the next-hop relay wireless communication terminal configured by the wireless communication node comprises at least one of:
an L2 identifier of the next-hop relay wireless communication terminal; or
a local identifier of the next-hop relay wireless communication terminal, wherein, in particular, the local identifier of the next-hop relay wireless communication terminal is uniquely allocated under the wireless communication node or under the root relay wireless communication terminal.

Preferably or in some embodiments, the wireless communication method further comprises at least one of:
recording, by the relay wireless communication terminal, the uplink routing information, wherein the uplink routing information comprises information on one relay wireless communication terminal from where the uplink data of the remote wireless communication terminal is received; or
identifying, by the relay wireless communication terminal, the next-hop relay wireless communication terminal where the downlink data of the remote wireless communication terminal is transmitted to, based on the uplink routing information recorded by the relay wireless communication terminal.

Preferably or in some embodiments, the wireless communication method further comprises at least one of:
receiving, by the relay wireless communication terminal from the remote wireless communication terminal or a served intermediate relay wireless communication terminal, a first uplink SRAP PDU, wherein a first uplink SRAP header of the first uplink SRAP PDU comprises at least one of:
   a local identifier of the remote wireless communication terminal;
   a local identifier of a served relay wireless communication terminal;
   an RB identifier; or
   a Uu RLC channel identifier of a served relay wireless communication terminal;
constructing, by the relay wireless communication terminal, a second uplink SRAP PDU, by adding an SRAP header to a first uplink SRAP PDU, wherein the SRAP header of the second uplink SRAP PDU comprises at least one of:
   a local identifier of the relay wireless communication terminal; or
   a Uu RLC channel identifier of the relay wireless communication terminal;
   or
transmitting, by the relay wireless communication terminal to an intermediate relay wireless communication terminal or a root relay wireless communication terminal, a second uplink SRAP PDU, by mapping the second uplink SRAP PDU to an egress PC5 RLC channel, based on a bearer mapping received from the wireless communication node.

Preferably or in some embodiments, the wireless communication method further comprises at least one of:
receiving, by the relay wireless communication terminal, a first downlink SRAP PDU, wherein an outermost SRAP header of the first downlink SRAP PDU comprises at least one of: an identifier of a served relay wireless communication terminal, an identifier of the remote wireless communication terminal, an RB identifier, or a Uu RLC channel identifier of a served relay wireless communication terminal;
removing, by the relay wireless communication terminal, an outermost SRAP header of a first downlink SRAP PDU; or
transmitting, by the relay wireless communication terminal to a served relay wireless communication terminal, a second downlink SRAP PDU, by mapping the second downlink SRAP PDU to an egress PC5 RLC channel towards the served relay wireless communication terminal based on a bearer mapping received from the wireless communication node.

Preferably or in some embodiments, the wireless communication method further comprises:
transmitting, by the relay wireless communication terminal to an intermediate relay wireless communication terminal or a root relay wireless communication terminal via a PC5 message, information of one or more remote wireless communication terminals for paging monitoring.

Preferably or in some embodiments, the wireless communication method further comprises at least one of:
transmitting, by the relay wireless communication terminal to an intermediate relay wireless communication terminal, a PC5 message for paging, wherein the PC5 message comprises information of one or more remote wireless communication terminals being paged.

Preferably or in some embodiments, the information of one or more remote wireless communication terminals for paging monitoring, or the information of one or more remote wireless communication terminals being paged comprises at least one of:
one or more L2 identifiers of the one or more remote wireless communication terminals;
one or more local identifiers of the one or more remote wireless communication terminals; or
one or more identifiers of the one or more remote wireless communication terminals.

Preferably or in some embodiments, the RB identifier is an end-to-end radio bearer between the remote wireless communication terminal and the wireless communication node.

Another aspect of the present disclosure relates to a wireless communication method. In an embodiment, the wireless communication method includes: performing, by a remote wireless communication terminal, a communication to a wireless communication node via two or more relay wireless communication terminals by receiving a multi-hop sidelink configuration transmitted by the wireless communication node, wherein the multi-hop sidelink configuration is transmitted to the remote wireless communication terminal and the two or more relay wireless communication terminals.

Various embodiments may preferably implement the following features:

Preferably or in some embodiments, the multi-hop sidelink configuration information comprises at least one of:
a local identifier of the remote wireless communication terminal;
a parent relay identifier of a parent relay wireless communication terminal;
a local identifier of an intermediate relay wireless communication terminal;
a bearer mapping; or
an identifier of a next-hop relay wireless communication terminal.

Preferably or in some embodiments, the bearer mapping comprises at least one of:
a bearer mapping configuration for the remote wireless communication terminal comprising at least one of:
   a Radio Bearer, RB, identifier; or
   an egress PC5 RLC channel identifier;
a bearer mapping configuration for an intermediate relay wireless communication terminal comprising at least one of:
   an RB identifier;
   an egress PC5 RLC channel identifier for an uplink transmission; or
   an egress PC5 RLC channel identifier for a downlink transmission;
a bearer mapping configuration for an intermediate relay wireless communication terminal acting as a UE-to-Network, U2N, relay wireless communication terminal comprising at least one of:
   an Rb identifier;
   a Uu Radio Link Control, RLC, channel identifier of a served intermediate relay wireless communication terminal;
   an egress Uu RLC channel identifier for an uplink transmission; or
   an egress PC5 RLC channel identifier for a downlink transmission;
a bearer mapping configuration for an intermediate relay wireless communication terminal acting as a U2N remote wireless communication terminal comprising at least one of:
   a Uu RLC channel identifier of the intermediate relay wireless communication terminal; or
   an egress PC5 RLC channel identifier;
or
a bearer mapping configuration for a root relay wireless communication terminal comprising at least one of:
   an RB identifier;
   a Uu RLC channel identifier of a served intermediate relay wireless communication terminal;
   an egress Uu RLC channel identifier for an uplink transmission; or
   an egress PC5 RLC channel identifier for a downlink transmission.

Preferably or in some embodiments, at least one of the following applies:
the local identifier of the remote wireless communication terminal is uniquely allocated under the wireless communication node, under a root relay wireless communication terminal, or under the parent relay wireless communication terminal;
the parent relay identifier is uniquely allocated under the wireless communication node;
the local identifier of the intermediate relay wireless communication terminal is uniquely allocated under the wireless communication node or under a root relay wireless communication terminal;
the identifier of the next-hop relay wireless communication terminal comprises at least one of a local identifier of the next-hop relay wireless communication terminal or a Layer 2, L2, identifier of the next-hop relay wireless communication terminal, wherein the local identifier of the next-hop relay wireless communication terminal is uniquely allocated under the wireless communication node or under a root relay wireless communication terminal; or
the parent relay wireless communication terminal is directly connected to the remote wireless communication terminal for providing a U2N functionality to support a connectivity to the wireless communication node for the remote wireless communication terminal.

Preferably or in some embodiments, the wireless communication method further comprises at least one of:
transmitting, by the remote wireless communication terminal to a relay wireless communication terminal, an uplink Sidelink Relay Adaptation Protocol, SRAP, Protocol Data Unit, PDU, of the remote wireless communication terminal, by mapping the SRAP PDU to an egress PC5 RLC channel based on a bearer mapping configured by the wireless communication node; or
receiving, by the remote wireless communication terminal from a relay wireless communication terminal, a downlink SRAP PDU.

Preferably or in some embodiments, an uplink SRAP header of the uplink SRAP PDU comprises at least one of:
a local identifier of the remote wireless communication terminal;
an RB identifier; or
a parent relay identifier of a parent relay wireless communication terminal.

Preferably or in some embodiments, the RB identifier is an end-to-end radio bearer between the remote wireless communication terminal and the wireless communication node.

Another aspect of the present disclosure relates to a wireless communication node. In an embodiment, the wireless communication node includes a communication unit and a processor. The processor is configured to: transmit, via the communication unit, multi-hop sidelink configuration information to two or more relay wireless communication terminals and a remote wireless communication terminal, wherein the remote wireless communication terminal communicates with the wireless communication node via the two or more relay wireless communication terminals.

Another aspect of the present disclosure relates to a relay wireless communication terminal. In an embodiment, the relay wireless communication terminal includes a communication unit and a processor. The processor is configured to: perform, via the communication unit, a packet forwarding between a wireless communication node and a remote wireless communication terminal based on multi-hop sidelink configuration information received from the wireless communication node to allow the remote wireless communication terminal and the wireless communication node to perform a communication via two or more relay wireless communication terminals.

Another aspect of the present disclosure relates to a remote wireless communication terminal. In an embodiment, the remote wireless communication terminal includes a communication unit and a processor. The processor is configured to: perform, via the communication unit, a communication to a wireless communication node via two or more relay wireless communication terminals by receiving transmitting a multi-hop sidelink configuration transmitted by the wireless communication node, wherein the multi-hop sidelink configuration is transmitted to the remote wireless communication terminal and to the two or more relay wireless communication terminals.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompanying drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps or operations in the methods disclosed herein are merely example approaches. Based upon design preferences, the specific order or hierarchy of steps or operations of the disclosed methods or processes can be re-arranged while remaining within the scope of the present disclosure. Thus, those of ordinary skill in the art will understand that the methods and techniques disclosed herein present various steps or operations in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a scenario of multi-hop SL relay according to an embodiment of the present disclosure.

FIG. 2 shows a tree topology for multi-hop SL relay according to an embodiment of the present disclosure.

FIG. 3 shows an architecture of a multi-hop SL relay according to an embodiment of the present disclosure.

FIG. 4 shows a control plane and user plane protocol stack for two SL relays of U2N relay according to an embodiment of the present disclosure.

FIGS. 5A and 5B show gNB configurations to remote UE and each Relay UE according to embodiments of the present disclosure.

FIG. 6 shows a protocol stack for multi-hop SL U2N relay according to an embodiment of the present disclosure.

FIGS. 7A and 7B show a gNB configuration to Remote UE and each Relay UE according to an embodiment of the present disclosure.

FIGS. 8A and 8B show flow charts according to embodiments of the present disclosure.

FIG. 9 shows an example of a schematic diagram of a wireless terminal according to an embodiment of the present disclosure.

FIG. 10 shows an example of a schematic diagram of a wireless network node according to an embodiment of the present disclosure.

FIGS. 11 to 13 show flowcharts of methods according to some embodiments of the present disclosure.

### DETAILED DESCRIPTION

In some embodiments, U2N relays may allow the network to extend its coverage to a remote UE via a single in coverage relay UE. This may be limited given the relatively short range for the sidelink (SL). Use of multiple hops may allow a range extension for U2N relays. Several new use cases may benefit from the extension of U2N relaying to multiple hops. For instance, Internet of Things (IoT) devices in disadvantaged deployment locations could be reached in scenarios of factory sensors and smart metering. In addition, wearables could benefit from a link to a companion smartphone, even when that smartphone is out of coverage and reaches the network via another UE.

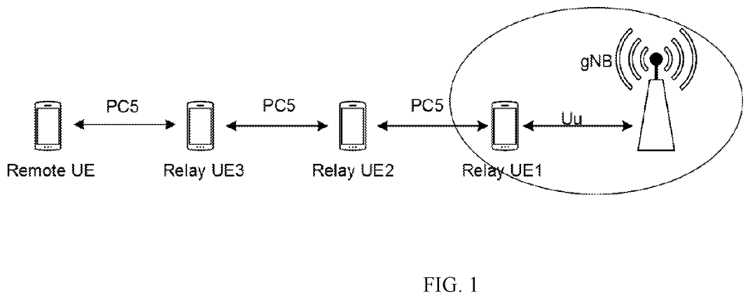

FIG. 1 shows a scenario of multi-hop SL relay according to an embodiment of the present disclosure. Therein, the relay UE1 may be a U2N Relay UE, which connects to the gNode B (gNB) directly via Uu (e.g., the Uu interface) and provides the U2N relay service for the downstream Relay UE/remote UEs. The remote UE may be a U2N Remote UE. The remote UE may establish its own Protocol Data Unit (PDU) session(s)/Data Radio Bearer(s) (DRB(s)) with the network. The remote UE's data towards gNB may be relayed by the multi-hop Relay UEs.

In some embodiments, the extension to multi-hop U2N relays may be expected to require enhancements to discovery and relay (re)selection. In addition, enhancements in adaptation layer protocol and control plane procedures may be required to support multiple hops. As per service requirements, the Quality of Service (QoS) may be important for the multi-hop U2N in order to meet the latency requirements despite the latency associated with relaying. Furthermore, enhancements may be required to ensure that robust mobility and service continuity can be maintained despite the increase in the number of hops and the support of mobility of not only the remote UE, but also any of the relay UEs serving it.

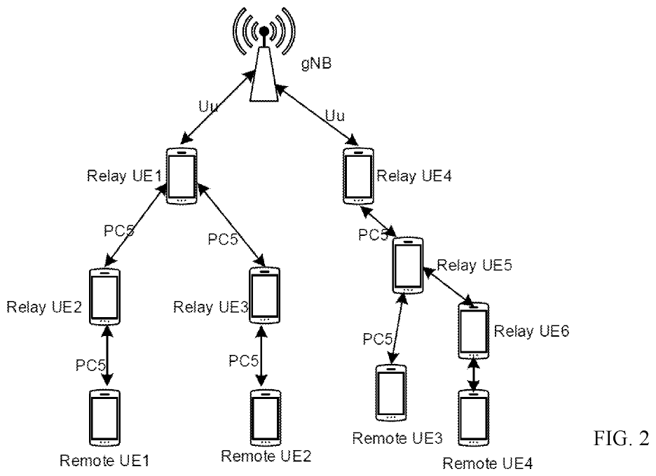

FIG. 2 shows a tree topology for multi-hop SL relay according to an embodiment of the present disclosure. In some embodiments, the Relay UE may connect to the gNB directly via Uu. The Relay UE may be called the root Relay or root U2N Relay UE (such as the Relay UE1 or the Relay UE4). In some embodiments, for a remote UE, its first hop Relay UE may be its access Relay UE. For example, the Remote UE 1's access relay (access U2N relay) may be the Relay UE2, and the Remote UE2's access relay may be the Relay UE3. The Relay UEs other than root Relays can be called intermediate Relay UEs (e.g., Relay UE5/6/2/3). A relay UE (e.g., Relay UE5) may be an access relay UE of one remote UE (e.g., Remote UE3) and an intermediate relay UE of other downstream UEs.

In the paragraphs below, some aspects of the present disclosure are provided, but the present disclosure is not limited thereto. Besides, different aspects described below can be combined unless expressly stated otherwise. In particular, aspects in any of the “Aspects” (e.g., Aspect 1) described below can be combined with aspects of any other “Aspect” (e.g., Aspect 2) described below and vice versa.

### Aspect 1

FIG. 3 shows an architecture of a multi-hop SL relay according to an embodiment of the present disclosure. In some embodiments, the Remote UE's access U2N relay may be a SL relay node 1. The SL relay node 1 may further act as a U2N remote to access a SL relay node 2. The SL relay node 2 may further act as a U2N remote to access a U2N relay UE, and the U2N relay UE (which may be called the root U2N relay UE) may provide access to the gNB. The SL relay node 1 and the SL relay node 2 may both have the capabilities of U2N relay and U2N remote operation. In some embodiments, each SL relay node may act as a U2N remote UE of its upstream node (e.g., the U2N relay UE or another SL relay node) and may act as a U2N relay UE of its downstream node (e.g., the U2N remote UE or a SL relay node). The SL relay node 1 and/or the SL relay node 2 can be called intermediate SL relay node.

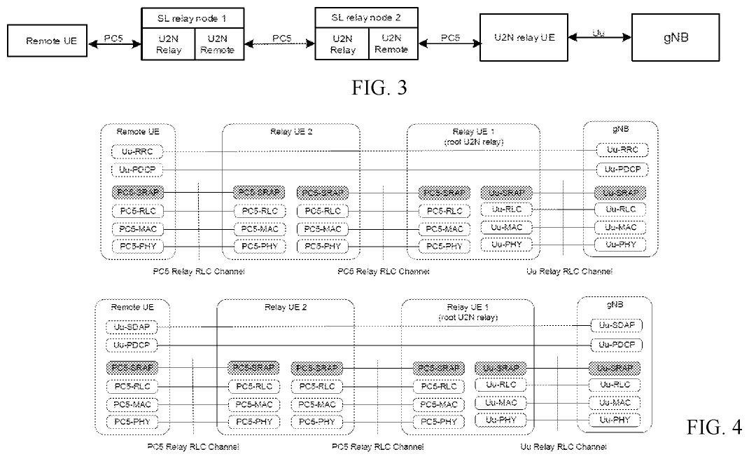

FIG. 4 shows a control plane and user plane protocol stacks for two SL relays of U2N relay according to an embodiment of the present disclosure. The Uu-Radio Resource Control (RRC)/Service Data Adaptation Protocol (SDAP)/Packet Data Convergence Protocol (PDCP) may be terminated between the Remote UE and the gNB, while the Sidelink Relay Adaptation Protocol (SRAP)/Radio Link Control (RLC)/Medium Access Control (MAC)/Physical Layer (PHY) may be terminated on each hop. For both PC5 and Uu SRAP header, they may consist of a remote UE local ID and a Bearer ID, which may be the same as a single U2N relay SRAP header according to an embodiment, wherein the local ID is 8 bits and the bearer ID is 5 bits.

In some embodiments, the remote UE local ID may be allocated by gNB. The remote UE local ID may uniquely identify a remote UE under the gNB or under a root U2N relay UE under the gNB. If the remote UE local ID is uniquely identifying a remote UE under a root U2N relay UE under the gNB, remote UEs under different root U2N relay UEs of the gNB may have the same local ID. Upon receiving a UL SRAP PDU, the gNB may identify the remote UE jointly by the local ID in the SRAP header and the root U2N relay UE from which the SRAP PDU is received.

In some embodiments, in the uplink, a remote UE's Uu SRB0 may be transmitted to the Relay UE2 (i.e., the remote UE's access U2N relay) via a specified SL-RLC0 without the SRAP header (since the remote UE has not got its local ID). For an SRAP packet received from the SL-RLC0, the Relay UE2 may recognize that the packet is for the remote UE's SRB0 and then add an SRAP header (e.g., by including the remote UE's local ID and Bearer ID (0)) for the packet and constructs the SRAP PDU. In some embodiments, the Relay UE2 may map the SRAP PDU to egress a PC5 Relay RLC channel based on bearer mapping configured by the gNB to transmit to the Relay UE1. The Relay UE1 may identify the remote UE and the Resource Block (RB) of the remote UE that the SPAP PDU belonging to, based on the SRAP header in the SRAP PDU. The Relay UE1 may map the SRAP PDU to egress the Uu Relay RLC channel based on a bearer mapping configured by the gNB.

In an embodiment, in the downlink, for remote UE's Uu SRB0, the gNB may encapsulate the SRAP PDU with the SRAP header including a remote UE local ID and RB ID and send it to a Relay UE1 via a Uu Relay RLC channel. The Relay UE1 may identify the remote UE and the Resource Block (RB) of the remote UE that the SPAP PDU belonging to, based on the SRAP header in the SRAP PDU. The Relay UE1 may map the SRAP PDU to egress the PC5 Relay RLC channel based on routing information and bearer mapping configured by gNB to transmit to Relay UE2. In some embodiments, the Relay UE2 may identify that the SRAP PDU belongs to remote UE's SRB0 based on SRAP header in the SRAP PDU. The Relay UE2 may remove the SRAP header and may send the SRAP packet to the remote UE via SL-RLC0.

In some embodiments, after the remote UE obtains its local ID from the gNB, for DRBs and SRBs other than SRB0, the remote UE may send the SRAP PDU with the SRAP header to the Relay UE via the mapped PC5 Relay RLC channel based on the bearer mapping configured by gNB. All relay UEs may directly forward the SRAP PDU to upstream node without changing the SRAP header. In some embodiments, in the downlink, all relay UEs may directly forward the SRAP PDU to a downstream node (including the remote UE) without changing the SRAP header.

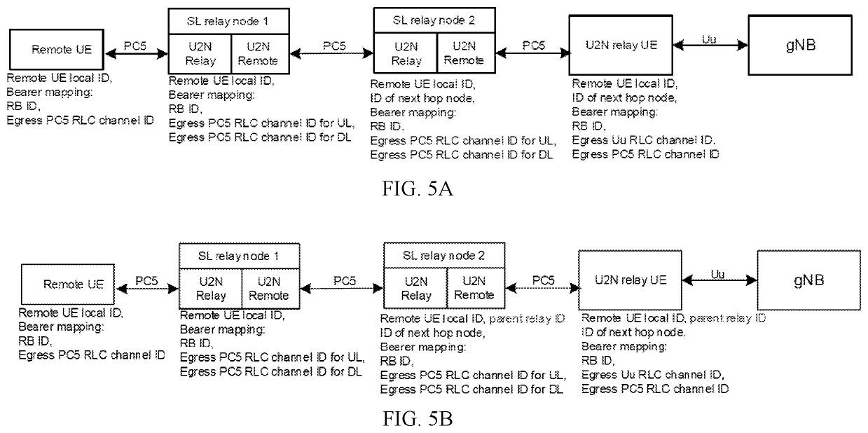

FIGS. 5A and 5B show gNB configurations to the remote UE and each Relay UE according to embodiments of the present disclosure.

In some embodiments, for each intermediate SL relay node (e.g., the SL relay node 1/2), the gNB may configure the local ID and bearer mapping for each remote UE (identified by L2 ID). The bearer mapping may include at least one of: RB ID, UL egress PC5 RLC channel, or DL egress PC5 RLC channel. For downlink egress PC5 Relay RLC channel determination, besides bearer mapping, each relay UE may know to which next hop/downstream node the remote UE's SRAP PDU may be forwarded next. As shown in FIG. 2, upon receiving a remote UE1's traffic from the gNB, the Relay UE1 may know that the remote UE1's traffic may be transmitted/forwarded to Relay UE2 or Relay UE3. For this purpose, at least two ways can be considered:

1) The gNB may configure the routing information together with the bearer mapping to each Relay UE. In some embodiments, the remote UE's access U2N relay UE may not be configured. The routing information may indicate the identification of the next hop/downstream node for a remote UE's bearer mapping (i.e., towards which the egress PC5 Relay RLC channel in the bearer mapping may be applied). The identification of the next hop node may include at least one of: the L2 ID of the next hop node, or the local ID of the next hop node. As shown in FIGS. 5A and 5B, the U2N relay UE and the SL relay node 2 may be configured with the routing information.

2) Assuming each Relay UE has the capability of autonomic learning and/or routing recording, upon receiving a remote UE's (identified by the local ID in SRAP header) data packet in uplink from an intermediate relay node, the Relay UE may record the intermediate relay node info for the remote UE data routing. In some embodiments, when receiving the remote UE's data in the downlink, the Relay UE can identify the next hop node based on the recorded uplink routing info of the remote UE. For example, the SL relay node 2 may record that remote UE1's data is relayed by SL relay node 1, the remote UE2's data is relayed by SL relay node 1a in uplink, then in the downlink, SL relay node 2 may send the remote UE1's data to the SL relay node 1 while sending the remote UE2's data to the SL relay node 1a.

In FIG. 4, for the Relay UE2's own signalling, the Relay UE2's SRB0 may be transmitted to the Relay UE1 via a specified SL-RLC0. The Relay UE1 may add an SRAP header and may send the SRAP PDU to the gNB via the Uu RLC channel based on the bearer mapping configured by the gNB. The gNB may allocate a local ID to the Relay UE2. The Relay UE2 may use the local ID for its own signalling and data transmission/reception. That is, the Remote UE's data and the Relay UE2's own data may be differentiated by different local IDs.

### Aspect 2

In some embodiments, for the protocol stacks in FIG. 4, a new SRAP header may be considered. The SRAP header of SRAP PDUs over PC5 interface and Uu interface may include at least one of: a local ID of the remote UE, a parent relay ID, and/or a Bearer ID. The local ID of remote UE may be allocated by the gNB, and it may be unique under the remote UE's parent/access relay node. The parent relay ID may be an ID of the remote UE's parent/access node, which may be allocated by the gNB and unique under the gNB. The local ID and the parent relay ID may be used jointly for the gNB to identify a remote UE.

In some embodiments, the SRAP header of SRAP PDU may include at least one of: a local ID of the remote UE, a Bearer ID, and/or a destination ID. The destination ID may be the L2 ID or local ID (allocated by gNB) of a root relay UE. Or the destination ID may be an ID of a gNB-DU, or an ID of the gNB. gNB configures the destination ID to the remote UE and each relay UE along the (selected) relay path.

In some embodiments, the gNB may send the parent relay ID of the remote UE's parent/access node to the remote UE. In the uplink data transmission, the remote UE may construct the SRAP PDU with an SRAP header including the parent relay ID (and remote UE local ID and Bearer ID). In some embodiments, the gNB may send the parent relay ID of the remote UE's parent/access node to the remote UE's parent/access node.

In some embodiments, when configuring the bearer mapping of the remote UE to each Relay UE (except the remote UE's parent/access relay node), besides the bearer mapping and the remote UE local ID, the parent relay ID of remote UE's parent/access relay node may also be included.

### Aspect 3

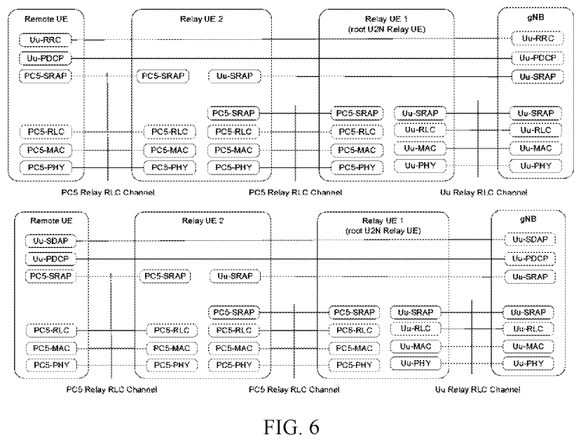

FIG. 6 shows a protocol stack for multi-hop SL U2N relay according to an embodiment of the present disclosure. The Uu RRC/SDAP/PDCP may be terminated at the remote UE and the gNB. The SRAP for the Remote UE may be terminated over PC5 between the Remote UE and the Relay UE2 and over the Uu between the Relay UE2 and the gNB. The SRAP for the Relay UE2 may be terminated over PC5 between the Relay UE2 and the Relay UE1 and over the Uu between the Relay UE1 and the gNB. In some embodiments, for each Remote UE and each intermediate Relay node, the PC5 SRAP may be terminated between the Remote UE/intermediate relay node and its access U2N relay UE. The Uu SRAP may be terminated between the access U2N relay UE and the gNB.

In some embodiments, for the Remote UE's SRAP PDU (including PC5 and Uu), the SRAP header (the third row from above) may include the remote UE's local ID and Bearer ID. For intermediate relay node's SRAP PDU, the SRAP header (the fourth row from above) may include the intermediate relay node's local ID and Bearer ID/Uu RLC channel ID. The Remote UE's (or intermediate relay node's) SRAP PDU may be encapsulated in its access U2N relay UE's SRAP PDU. In some embodiments, the local ID of each Remote UE/intermediate relay node may be unique under the gNB, or unique under the root U2N relay UE of the gNB, or unique under its access U2N relay UE of the gNB.

For each intermediate relay node (e.g., Relay UE2 in FIG. 6, or SL relay node 1/2 in FIG. 3), it may be configured with two parts of configuration by gNB:

Part-1: The configuration for the node acting as an access U2N relay UE for a served remote node (Remote UE/SL relay node): local ID of the served remote node (identified by L2 ID), bearer mapping (Bearer ID (remote UE's Uu SRB/DRB ID, or SL relay node's Uu RLC channel ID), egress Uu RLC channel ID, egress PC5 RLC channel ID).

Part-2: The configuration for the node acting as a U2N remote UE: local ID of the node (the node is identified by L2 ID), bearer mapping (Uu RLC channel ID (of the node), egress PC5 RLC channel ID).

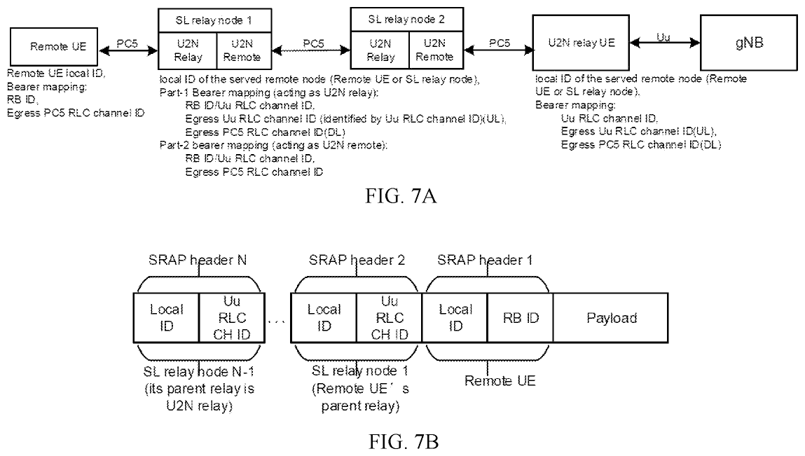

FIGS. 7A and 7B shows a gNB configuration to Remote UE and each Relay UE according to an embodiment of the present disclosure.

In some embodiments, the Remote UE may have its local ID from the gNB. Upon receiving a PDCP PDU from an upper layer entity, the Remote UE may construct an SRAP PDU by adding an SRAP header (e.g., the SRAP header 1 in FIG. 7B) including its local ID and Bearer ID and may map the SRAP PDU to the egress PC5 Relay RLC channel based on configured bearer mapping.

In some embodiments, upon receiving an SRAP PDU in uplink, the intermediate relay node (e.g., Relay UE2) may identify the remote UE (or the served remote node/SL relay node) and bearer ID (or Uu RLC channel ID) based on the SRAP header and may decide the egress Uu Relay RLC channel (identified by Uu RLC channel ID) based on the configured Part-1 bearer mapping. The intermediate relay node may construct a new SRAP PDU by adding an SRAP header (e.g., the SRAP 2 in FIG. 7B, until the SRAP header N), including the local ID of the intermediate relay node and the identified Uu RLC channel ID and may map the new SRAP PDU to the egress PC5 Relay RLC channel based on the Part-2 bearer mapping for the identified Uu RLC channel ID.

In some embodiments, upon receiving an SRAP PDU in uplink, the root U2N relay UE (e.g., Relay UE1) may identify the last hop node (acting as a U2N remote UE) and the Uu RLC channel ID based on the outermost SRAP header and may maps the SRAP PDU to the egress Uu Relay RLC channel based on the configured bearer mapping. Upon receiving an SRAP PDU in uplink, the gNB may remove all the SRAP header and may identify the remote UE and Bearer ID based on the innermost SRAP header and may deliver the SRAP SDU to the corresponding upper layer entity.

In some embodiments, for a Remote UE's downlink data, upon receiving a PDCP PDU from an upper layer entity, the gNB may constructs the SRAP PDU by adding the SRAP header (e.g., the SRAP header 1 in FIG. 7B) including the remote UE's local ID and Bearer ID and may decide the egress Uu Relay RLC channel (identified by Uu RLC channel ID of the serving relay/remote UE's access/parent relay). Based on the relay path, the gNB may construct a new SRAP PDU by adding the SRAP header (e.g., the SRAP header 2 in FIG. 7B) including the local ID of the remote UE's access U2N relay node (the upstream node) and the identified Uu RLC channel ID, and so on (until the SRAP header N).

In some embodiments, upon receiving an SRAP PDU in downlink, the root U2N relay UE may identify the served remote node (Remote UE or SL relay node) and Bearer ID/Uu RLC channel ID according to the outermost SRAP header (e.g., the SRAP header N in FIG. 7B). The root U2N relay UE may remove the outermost SRAP header and may map the SRAP PDU to egress PC5 Relay RLC channel towards the identified served remote node based on the configured bearer mapping.

In some embodiments, upon receiving an SRAP PDU in downlink, the intermediate relay node may identify the served remote node (Remote UE or SL relay node) and Bearer ID/Uu RLC channel ID according to the outermost SRAP header. The intermediate relay node may remove the outermost SRAP header and may map the SRAP PDU to egress PC5 Relay RLC channel towards the identified served remote node based on the configured bearer mapping (Part-1).

In some embodiments, upon receiving an SRAP PDU in downlink, the Remote UE may identify the SRB/DRB based on the Bearer ID in the SRAP header and may deliver the corresponding SRAP SDU (e.g., after removing the SRAP header) to the corresponding upper layer entity.

### Aspect 4

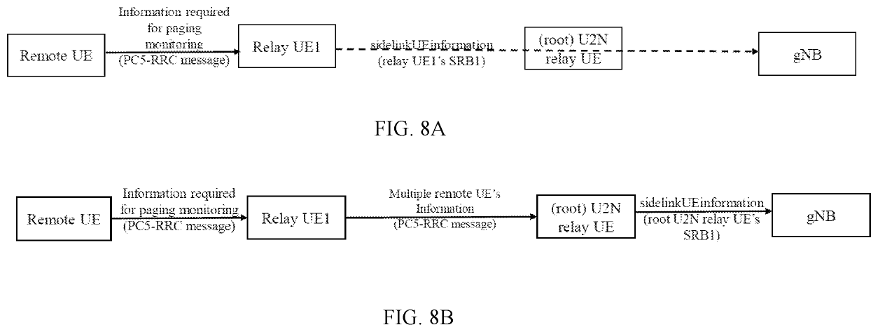

FIGS. 8A and 8B show flow charts according to embodiments of the present disclosure.

In some embodiments, the remote UE may send the information required for paging monitoring (such as 5G-S-TMSI/I-RNTI, DRB cycle) to its access/parent relay UE (e.g., Relay UE1) via a PC5-RRC message. The access/parent relay UE may send the information of the remote UE to the gNB through sidelink UE information via multi-hop SL relays. The gNB may send the remote UE's paging to the access/parent relay UE through a dedicated RRC message. The message may include remote UE ID (5G-S-TMSI or I-RNTI). The access/parent relay UE may send the remote UE's paging to the remote UE via a PC5 RRC message.

In some embodiments, when receiving the information required for paging monitoring from the connected remote UEs, the relay UE (e.g., relay UE1) may further act as a remote to send the information of multiple connected remote UEs/served relay nodes to its access/parent relay UE (e.g., relay UE2) via a PC5-RRC message. In some embodiment, the information of each remote UE/served relay node may further include the remote UE's/served relay node's L2 ID or local ID. The relay UE2 may further act as a remote to send the information of multiple remote UEs to its access/parent relay UE (e.g., root U2N relay UE) via a PC5-RRC message. The root U2N relay UE may send the information of multiple remote UEs to gNB through a sidelink UE information message. In an embodiment, the root U2N relay UE may know the required information for paging monitoring of multiple downstream remote UEs. It may monitor these remote UEs'paging occasion if the active DL BWP is configured with common search space including paging search space. Alternatively, the gNB may send the remote UE's paging to the root U2N relay UE via a dedicated RRC message. The paging may be sent together with remote UE's L2 ID or local ID.

In some embodiments, upon monitoring/receiving the remote UE's paging, the root U2N relay UE may send the remote UE's paging to the downstream intermediate relay UE via a PC5-RRC message based on routing information (as discussed above) or the stored routing record (based on uplink transmission), and so on. In the PC5-RRC message, for each remote UE's paging (including remote UE ID (5G-Serving Temporary Mobile Subscriber Identity (S-TMSI) or Inactive-Radio Network Temporary Identifier (I-RNTI))), the remote UE's L2 ID or local ID may be further included for downlink routing. In an embodiment, in one PC5-RRC message, it may include the paging (including remote UE ID (5G-S-TMSI or I-RNTI)) of multiple remote UEs that these remote UEs are all relayed through the downstream intermediate relay UE.

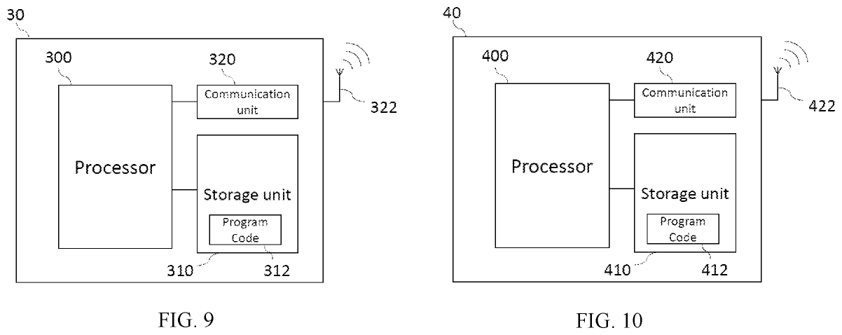

FIG. 9 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 310 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 or via wiring.

In an embodiment, the storage unit 310 and the program code 312 may be omitted and the processor 300 may include a storage unit with stored program code.

The processor 300 may implement any one of the steps or operations in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the remote UE, the U2N relay UE or the U2N remote UE described in this disclosure. In some embodiments, the processor 300 and the communication unit 320 collaboratively perform the operations described in this disclosure. For example, the processor 300 performs operations and transmit or receive signals, message, and/or information through the communication unit 320.

FIG. 10 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the gNB described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 410 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an embodiment, the communication unit 420 transmits and receives the signals via at least one antenna 422 or via wiring.

In an embodiment, the storage unit 410 and the program code 412 may be omitted. The processor 400 may include a storage unit with stored program code.

The processor 400 may implement any steps or operations described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of gNB described in this disclosure. In some embodiments, the processor 400 and the communication unit 420 collaboratively perform the operations described in this disclosure. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a gNB). In an embodiment, the wireless communication terminal may be implemented by using the wireless communication terminal 30 described in this disclosure, but is not limited thereto.

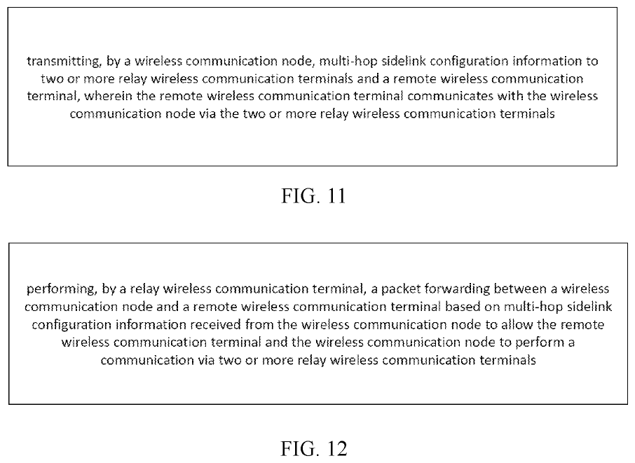

Referring to FIG. 11, in an embodiment, the wireless communication method includes: transmitting, by a wireless communication node, multi-hop sidelink configuration information to two or more relay wireless communication terminals and a remote wireless communication terminal, wherein the remote wireless communication terminal communicates with the wireless communication node via the two or more relay wireless communication terminals.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., a U2N relay UE or a U2N remote UE). In an embodiment, the wireless communication terminal may be implemented by using the wireless communication terminal 30 described in this disclosure, but is not limited thereto.

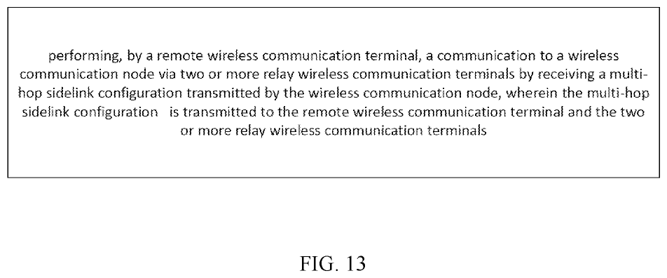

Referring to FIG. 12, in an embodiment, the wireless communication method includes: performing, by a relay wireless communication terminal, a packet forwarding between a wireless communication node and a remote wireless communication terminal based on multi-hop sidelink configuration information received from the wireless communication node to allow the remote wireless communication terminal and the wireless communication node to perform a communication via two or more relay wireless communication terminals.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a Remote UE). In an embodiment, the wireless communication node may be implemented by using the wireless communication node 40 described in this disclosure, but is not limited thereto.

Referring to FIG. 13, in an embodiment, the wireless communication method includes: performing, by a remote wireless communication terminal, a communication to a wireless communication node via two or more relay wireless communication terminals by receiving a multi-hop sidelink configuration transmitted by the wireless communication node, wherein the multi-hop sidelink configuration is transmitted to the remote wireless communication terminal and the two or more relay wireless communication terminals.

Details in this regard can be ascertained with reference to the paragraphs above, and will not be repeated herein.

In some embodiments, the wireless communication terminal used in the present disclosure may indicate the Remote UE, the U2N relay UE or the U2N remote UE described above.

In some embodiments, the wireless communication node used in the present disclosure may indicate the gNB described above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is understood that, in the present disclosure, the term “and/or” or symbol “/” may include any and all combinations of one or more of the associated listed items. For example, A and/or B and/or C includes any and all combinations of one or more of A, B, and C, including A, B, C, A and B, A and C, B and C, and a combination of A and B and C. Likewise, A/B/C includes any and all combinations of one or more of A, B, and C, including A, B, C, A and B, A and C, B and C, and a combination of A and B and C.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, operations, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps or operations of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

We claim:

1. A wireless communication method comprising:
transmitting, by a wireless communication node, multi-hop sidelink configuration information to two or more relay wireless communication terminals and a remote wireless communication terminal,
wherein the remote wireless communication terminal communicates with the wireless communication node via the two or more relay wireless communication terminals.

2. The wireless communication method of claim 1, wherein the multi-hop sidelink configuration information comprises at least one of:
a local identifier of the remote wireless communication terminal; or
a bearer mapping.

3. The wireless communication method of claim 2, wherein the bearer mapping comprises:
a bearer mapping configuration for an intermediate relay wireless communication terminal comprising at least one of:
an RB identifier;
an egress PC5 RLC channel identifier for an uplink transmission; or
an egress PC5 RLC channel identifier for a downlink transmission.

4. The wireless communication method of claim 3, wherein the RB identifier is an end-to-end radio bearer identifier between the remote wireless communication terminal and the wireless communication node.

5. The wireless communication method of claim 2, wherein the local identifier of the remote wireless communication terminal is uniquely allocated under a root relay wireless communication terminal.

6. A wireless communication method comprising:
performing, by a relay wireless communication terminal, a packet forwarding between a wireless communication node and a remote wireless communication terminal based on multi-hop sidelink configuration information received from the wireless communication node to allow the remote wireless communication terminal and the wireless communication node to perform a communication via two or more relay wireless communication terminals.

7. The wireless communication method of claim 6, wherein the multi-hop sidelink configuration information comprises at least one of:
a local identifier of the remote wireless communication terminal; or
a bearer mapping.

8. The wireless communication method of claim 7, wherein the bearer mapping comprises:
a bearer mapping configuration for an intermediate relay wireless communication terminal comprising at least one of:
an RB identifier;
an egress PC5 RLC channel identifier for an uplink transmission; or
an egress PC5 RLC channel identifier for a downlink transmission.

9. The wireless communication method of claim 7, wherein the local identifier of the remote wireless communication terminal is uniquely allocated under a root relay wireless communication terminal.

10. The wireless communication method of claim 6, further comprising at least one of:
receiving, by the relay wireless communication terminal from the remote wireless communication terminal or an intermediate relay wireless communication terminal, a Sidelink Relay Adaptation Protocol (SRAP) Protocol Data Unit (PDU) of the remote wireless communication terminal;
transmitting, by the relay wireless communication terminal to an intermediate relay wireless communication terminal or a root relay wireless communication terminal, a SRAP PDU of the remote wireless communication terminal, by mapping the SRAP PDU to an egress PC5 RLC channel for uplink transmission, based on a bearer mapping received from the wireless communication node;
receiving, by the relay wireless communication terminal from a root relay wireless communication terminal or an intermediate relay wireless communication terminal, an SRAP PDU of the remote wireless communication terminal; or
transmitting, by the relay wireless communication terminal to a next-hop relay wireless communication terminal, an SRAP PDU, of the remote wireless communication terminal, particularly by mapping the SPAP PDU to an egress PC5 RLC channel towards the next-hop relay wireless communication terminal, based on a bearer mapping received from the wireless communication node.

11. The wireless communication method claim 6, further comprising:
transmitting, by the relay wireless communication terminal to an intermediate relay wireless communication terminal or a root relay wireless communication terminal via a PC5 message, information of one or more remote wireless communication terminals for paging monitoring.

12. The wireless communication method of claim 6, further comprising:
transmitting, by the relay wireless communication terminal to an intermediate relay wireless communication terminal, a PC5 message for paging, wherein the PC5 message comprises information of one or more remote wireless communication terminals being paged.

13. The wireless communication method of claim 11, wherein the information of one or more remote wireless communication terminals for paging monitoring, or the information of one or more remote wireless communication terminals being paged comprises:
one or more identifiers of the one or more remote wireless communication terminals.

14. The wireless communication method of claim 8, wherein the RB identifier is an end-to-end radio bearer identifier between the remote wireless communication terminal and the wireless communication node.

15. A relay wireless communication terminal, comprising:
a communication unit; and
a processor configured to:
perform, via the communication unit, a packet forwarding between a wireless communication node and a remote wireless communication terminal based on multi-hop sidelink configuration information received from the wireless communication node to allow the remote wireless communication terminal and the wireless communication node to perform a communication via two or more relay wireless communication terminals.

16. The relay wireless communication terminal of claim 15, wherein the processor is further configured to:
receive, via the communication unit from the remote wireless communication terminal or an intermediate relay wireless communication terminal, a Sidelink Relay Adaptation Protocol (SRAP) Protocol Data Unit (PDU) of the remote wireless communication terminal;
transmit, via the communication unit to an intermediate relay wireless communication terminal or a root relay wireless communication terminal, a SRAP PDU of the remote wireless communication terminal, by mapping the SRAP PDU to an egress PC5 RLC channel for uplink transmission, based on a bearer mapping received from the wireless communication node;
receive, via the communication unit from a root relay wireless communication terminal or an intermediate relay wireless communication terminal, an SRAP PDU of the remote wireless communication terminal; or
transmit, via the communication unit to a next-hop relay wireless communication terminal, an SRAP PDU, of the remote wireless communication terminal, particularly by mapping the SPAP PDU to an egress PC5 RLC channel towards the next-hop relay wireless communication terminal, based on a bearer mapping received from the wireless communication node.

17. The relay wireless communication terminal of claim 15, wherein the processor is further configured to:
transmit, via the communication unit to an intermediate relay wireless communication terminal or a root relay wireless communication terminal via a PC5 message, information of one or more remote wireless communication terminals for paging monitoring.

18. The relay wireless communication terminal of claim 15, wherein the processor is further configured to:
transmit, via the communication unit to an intermediate relay wireless communication terminal, a PC5 message for paging, wherein the PC5 message comprises information of one or more remote wireless communication terminals being paged.

19. The relay wireless communication terminal of claim 17, wherein the information of one or more remote wireless communication terminals for paging monitoring, or the information of one or more remote wireless communication terminals being paged comprises:
one or more identifiers of the one or more remote wireless communication terminals.

20. A wireless communication node, comprising:
a communication unit; and
a processor configured to carry out the method of claim 1.
